(19) United States
(12) Patent Application Publication
(10) Pub. No.: US 2020/0299971 A1
(43) Pub. Date: Sep. 24, 2020

(54) WALL PANELS HAVING ADHESIVE COATING

(71) Applicant: Xylo Technologies AG, Niederteufen (CH)

(72) Inventors: Justin Heim, Seneca, PA (US); Christian Schweitzer, Shippenville, PA (US)

(73) Assignee: Xylo Technologies AG, Niederteufen (CH)

(21) Appl. No.: 16/759,580

(22) PCT Filed: Oct. 29, 2018
(86) PCT No.: PCT/EP2018/079600

§ 371 Date: Apr. 27, 2020

(30) Foreign Application Priority Data
Oct. 30, 2017 (DE) 20 2017 106 601.0

(51) Int. Cl. E04F 13/08; E04F 15/02; B32B 7/12; B32B 29/00; B32B 21/14

(52) U.S. Cl. CPC E04F 13/0885; E04F 13/0871; E04F 13/0864; E04F 15/0215; B32B 2471/00; B32B 29/002; B32B 21/14; B32B 2607/02; B32B 7/12

(57) ABSTRACT

A wall panel, ceiling panel, or floor panel may be provided having a T-shaped profile in which the web base area and/or the surface of the limbs facing the installation side is/are coated with an adhesive regionally or all over. Also provided may be a wall cladding, ceiling cladding, or floor cladding that is formed from a plurality of such panels.

### CROSS-REFERENCE TO RELATED APPLICATIONS

This application is a 371 nationalization of international patent application PCT/EP2018/079600 filed Oct. 29, 2018, which claims priority under 35 USC § 119 to German patent application DE 20 2017 106 601.0 filed Oct. 30, 2017. The entire contents of each of the above-identified applications are hereby incorporated by reference.

### TECHNICAL FIELD

The invention relates to a wall panel, ceiling panel, or floor panel having a T-shaped profile in which the web base area and/or the surface of the limbs facing the installation side is/are coated with an adhesive regionally or all over. The invention further relates to a wall cladding, ceiling cladding, or floor cladding that is formed from a plurality of such panels.

### BRIEF DESCRIPTION OF THE DRAWINGS

FIG. 1 schematically shows a panel in accordance with the invention having a T-shaped profile;

FIG. 2 shows a wall cladding in accordance with the invention that can be manufactured using the panel in accordance with the invention;

FIG. 3 shows a wall cladding in accordance with the invention comprising panels having chamfered limb edge surfaces;

FIG. 4 shows a wall cladding in accordance with the invention in which the panels from FIG. 1 have been arranged horizontally offset in two installation planes;

FIG. 5 shows a wall cladding in accordance with the invention comprising panels having a wave-like structure in the same direction on both sides of the limbs;

FIG. 6 shows a wall cladding in accordance with the invention in which the panels having a wave-like structure in the same direction on both sides of the limbs have been arranged horizontally offset in two planes;

FIG. 7 shows a wall cladding in accordance with the invention in which the panels from FIG. 1 have been arranged horizontally offset in three installation planes;

FIG. 8 shows a wall cladding in accordance with the invention in which panels comprising a trapezoidal web and slanted limbs have been arranged next to one another in rows in an installation plane;

FIG. 9 shows a wall cladding in accordance with the invention in which the panels whose profiles result from two trapezoids of different widths are arranged in two installation planes;

FIG. 10 shows a wall cladding in accordance with the invention having an installation plane in which panels were used whose limbs have a curved edge surface; and

FIG. 11 shows, in a manner similar to FIG. 8, a wall cladding in accordance with the invention in which the panels comprising a trapezoidal web and slanted limbs have been arranged next to one another in rows in an installation plane. Unlike FIG. 8, the web of the panels that were used to manufacture the wall cladding in FIG. 11 each include an acute angle with the limbs; and

FIG. 12 shows a wall cladding in accordance with the invention in which the panels from FIG. 11 have been arranged horizontally offset in two installation planes.

### DETAILED DESCRIPTION

The wall panels, ceiling panels, or floor panels known from the prior art are usually designed such that a gapless or spaceless wall cladding, ceiling cladding, or floor cladding is achieved. The completed cladding should classically create an impression that is as homogeneous as possible and should conceal irregularities or structures of an underlying surface (for example crumbling plaster or another defective covering).

Modern wall cladding, ceiling cladding, or floor cladding is, however, more than just a “camouflaging” element. It can admittedly still conceal surfaces that are generally not perceived as attractive or appealing. However, they furthermore also represent an interior design tool. They are used to turn unimpressive spaces into eye-catchers and to give them the appearance of higher value. Cladding furthermore serves as a rule the division of a space into different regions and thus contribute to giving the space a tidy and neat effect.

To achieve this, professional interior designers have previously used panels that have to be attached with the aid of mechanical fastening systems. The installation of such panels, however, requires special professional knowledge in the area and is not suitable for amateurs or the growing “do-it-yourself” industry. In addition, special tools are often required to attach the mechanical fastening systems.

It is therefore the object of the present invention to provide a wall panel, ceiling panel, or floor panel that can be fastened to most surfaces permanently and simply without further aids or special skill being required for this purpose. It is furthermore the object of the present invention to design the panels such that they can either be installed in one plane and can be assembled to form a single-layer cladding or can be arranged in a plurality of planes such that a regular 3D effect results.

In addition, it was the object of the present invention to provide instructions on the assembly of the wall panels, ceiling panels, or floor panels and thereby to make the wall cladding, ceiling cladding, or floor cladding per se available.

The wall panel, ceiling panel, or floor panel has a T-shaped profile, with the profile comprising a web at an installation side of the panel and two limbs at a visible side of the panel and with the web having a planar base surface and the base surface of the web and/or a surface of limbs facing the installation side being coated with an adhesive regionally or all over.

“Adhesive in the sense of the invention” is understood here such that the surface of the limb coated with adhesive is suitable for adhesion to a surface contacted by the surface of the limb. The adhesive is therefore “active” in the sense in accordance with the invention and is thus not yet hardened and/or already adhered to a second article. The panel in accordance with the invention is thus suitable for further adhesion to further articles, but is not adhered to further articles.

The term of the “T-shaped profile” is to be given a wide interpretation here. It, for example, includes embodiments in which the web does not form an angle of 90 ° with a limb. It furthermore covers embodiments in which the shortest side of the web does not automatically represent the base surface. Profiles are additionally called a “T-shaped profile” as part of the present invention in which the cross-section of the web is square or rectangular or has the shape of a trapezoid, a diamond, or a parallelogram.

The visible side of the panel is that side of the panel that faces the observer after the fastening of the panel to the wall, to the floor, or to the ceiling.

The regional coating of the base surface of the web and/or of the surface of the limbs facing the installation side can be due to a spray application of the adhesive with the aid of a nozzle.

It is moreover advantageous if the panel has a further adhesive coating at an edge surface of at least one limb. The cohesion of mutually adjacent panels in one plane can be promoted by this adhesive coating. At the same time, a possible warping of the panels due to stretching or shrinking is compensated. In addition, adjacent panels can be adhered to the limb edge surfaces by the adhesive coating such that a gas-filled space is produced below the panels that only displays a little gas exchange with the environmental air and thereby acts in a heat insulating and soundproof manner. This gas-filled space is bounded by the surface of the limbs of two adjacent panels facing the installation side and by the wall, the floor, or the ceiling. A further advantageous aspect of the further adhesive coating of an edge surface of at least one limb is that the adhesion produced between adjacent panels represents a moisture barrier.

Provision is made in a preferred variant of the panels that the limbs are arranged axially symmetrically with respect to the web. This means that the T-shaped profile is preferably such that it has a symmetry with respect to the axis that passes centrally through the base surface of the web.

It is additionally preferred if the limbs and the web are connected with shape matching and were produced from one piece. It is conceivable here that the T-shape was produced by means of injection molding in a corresponding injection mold. A grinding of a monolith in a T-shape having two limbs and a web or a cutting to shape of a solid material can likewise be considered.

The panel furthermore has a layer of veneering or of decor paper at the visible side in a preferred embodiment. This permits inexpensive materials to be used for the base body of the panel, that is, for the web and the limbs, and only to enhance the surface that is responsible for the visual impression. A fixing of the veneering or of the decor paper on the base body of the panel is preferably effected with the aid of an adhesive. It is additionally preferred if the veneering or the decor paper that forms the surface of the panel in this embodiment is sealed by a transparent, glossy, or matte lacquer. It is equally possible to apply a decor as such to the visible side, e.g. by painting on, coloring, or by other methods by which the appearance of the visible side can be influenced.

Instead of veneering, the substantial part of the panel preferably comprises a material selected from the group comprising wood, wood materials, in particular HDF and MDF, plastic, in particular PVC, cement fiber, plaster, metal, glass, ceramics, rock wool fiber materials (basalt fibers), and mixtures thereof. The panel particularly preferably comprises a material selected from the group comprising wood materials such as HDF, MDF, PVC, cement fibers, plaster, metal, glass, and ceramics. It is in particular preferred in this respect if the material makes up more than 90%, particularly preferably more than 95%, of the total weight.

The adhesive with which the panel is coated regionally or all over is preferably a pressure sensitive adhesive. In particular pressure sensitive adhesives are suitable that were manufactured using an acrylate, for example polyacrylates, acrylic foams, or modified polyacrylates. Pressure sensitive adhesives on a polyurethane base are equally suitable.

To achieve a better transport capability of the panels, it is furthermore preferred if the adhesive coating is covered by a reversibly releasable release paper, particularly preferably by a release paper comprising polyethylene or coated polyethylene. Alternatively, the release paper can also comprise predominantly kraft paper instead of polyethylene. The release paper prevents the panels from already adhering to one another on the transport to the place of destination and from thereby becoming unusable. The user has to release the release paper and expose the adhesive coating for application to a wall, a ceiling, or a floor.

The panel preferably has a length of 100 to 2000 mm and/or a width of 30 to 250 mm and/or a thickness of 4 to 10 mm. The panel particularly preferably has a length of 1210 mm, a width of 165 mm, and a thickness of 6 mm.

In a further variant of the invention, the edge surface of the limbs has a chamfer, a rounded portion, or a curvature on one side or on both sides. A chamfer is a beveled surface of a workpiece edge that reduces the risk of the user injuring himself at the edge surface. The chamfer moreover facilitates the installation of the panel. The chamfer preferably has an angle between 40 and 50° toward the plane. The chamfer, the rounded portion, or the curvature is preferably likewise coated with a UV hardening protective lacquer.

The edge surface of the limbs per se can also be coated with a UV hardening protective lacquer. This increases the abrasion resistance and scratch resistance of the panels and also protects the edge surface from other mechanical damage so that the panel becomes more durable and long-lasting.

The UV hardening protective lacquer for the edge surface of the limbs is preferably selected from the group comprising matte lacquer and glossy clear lacquer.

Provision is made in an advantageous embodiment of the panel that the surface of the limbs facing the visible side has an arching or a structure, with the structure preferably comprising regular bulges and recesses. It is furthermore preferred if the surface of the limbs facing the visible side and the surface of the limbs facing the installation side have a structure, with the structure of both surfaces being either in the same direction or in the opposite direction with respect to an outer plane, e.g. the plane of the wall.

If the structure is regular and is in the same direction or in the opposite direction on the oppositely disposed surfaces of the limbs, an arrangement of identical panes in a plurality of planes without any intermediate spaces is possible. Bulges at the surface of the limbs facing the installation side conform with recesses at the visible side of the limbs.

It is additionally desirable for the base surface of the web and/or the edge surface of the limbs and/or the surface of the limbs facing the visible side and/or the surface of the limbs facing the installation side to have a core roughness depth measured in accordance with DIN EN ISO 13565-1 between 20 and 60 μm. It is hereby ensured that the adhesive coating adheres to the panel and can impart a permanent contact to other surfaces.

A right-angled, beveled, or rounded transition can thus be present between the surface of the limbs facing the installation side and the web of the panel. With panels whose T-shaped profiles have been produced by grinding a monolith or by cutting a solid material to size, beveled or slightly rounded transitions are particularly preferred since no exact right angles can typically be produced with these processing techniques.

The wall cladding, ceiling cladding or floor cladding in accordance with the invention is formed from a plurality of the above-described panels.

The cladding is characterized in a preferred variant in that the panels are fastened to a wall, a ceiling, or a floor by means of an adhesive coating of the base surface of the web in a first installation plane.

In a further variant, the panels are positioned next to one another in rows in the first installation plane such that the edge surfaces of limbs of adjoining panels are adjacent one another.

It is, however, particularly preferred that the wall cladding, ceiling cladding, or floor cladding is designed such that panels in a second installation plane are also fastened to the panels on the first installation plane by means of an adhesive coating on the surface of the limbs facing the installation plane so that the panels of the first installation plane are at least partially concealed for an observer on the visible side by the panels of the second installation plane, with the edge surfaces of respective adjacent panels in the first installation plane preferably being adjacent to a side surface of the web of a panel in the second installation plane. In this embodiment, the cladding has an obvious 3D effect or a regular three-dimensional structure. The topmost layer of the panels can cast lines of shadow with a suitable lighting so that the effect is further amplified.

It is also possible that panels in a third installation plane are fastened to the panels of the second installation plane and/or to the panels of the first installation plane by means of an adhesive coating. A three-dimensional effect can also be observed here. In addition, the thickness of the cladding layer can be influenced by the number of installation planes.

In a preferred variant, the adhesive coating of the panels is the only fastening means that is applied to the panels. It is thus also preferred that no further adhesive and no screws, nails, clamps, staples, or pins, particularly preferably no further aids at all, are required for the permanent fastening of the cladding.

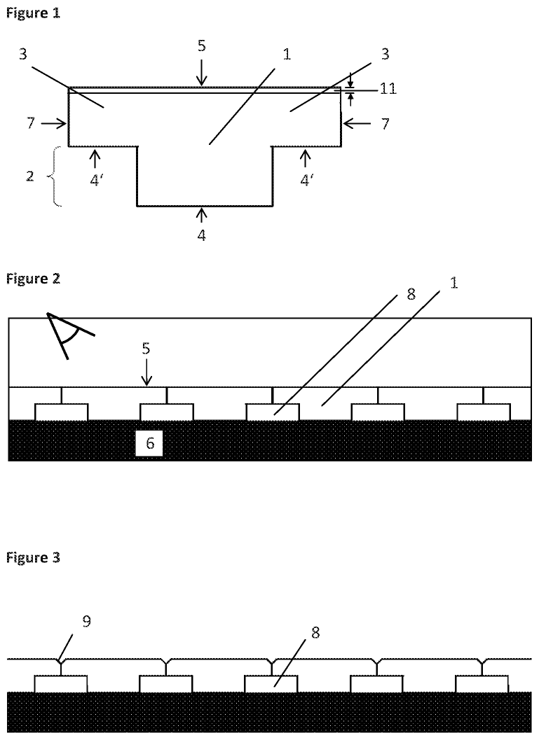

The invention will be described in more detail in the following with reference to FIGS. 1 to 9 without limiting the protective scope to these specific embodiments.

The cross-section of a panel in the sense of the present invention is shown in FIG. 1. It comprises the base body 1 as the panel per se and a top layer 11 of a veneering or a decor paper. As has already been indicated, the top layer 11 only makes up a small fraction of the total thickness of the panel. A suitable adhesive can be applied between the base body 1 of the panel and the top layer 11. The clear lacquer that can be applied over the top layer as a seal is not shown. The T-shaped profile of the panel has a web 2, on the one hand, and two limbs 3, on the other hand. The limbs each have an edge surface 7 and a side 4′ facing the installation side. The surface of the web facing the installation side is the base surface 4. The visible side 5 from where an observer can examine the cladding after the installation of the panels is directly opposite the installation side.

FIG. 2 shows a cladding that was obtained by the fastening of a plurality of panels 1 of the same type having T-shaped profiles to an installation side 6, a wall here. For reasons of clarity, the top layer of veneering or decor paper is no longer shown in this Figure and in all subsequent Figures. The panels of the same type are arranged here such that the edge surfaces of the limbs abut one another. An air-filled or gas-filled space 8 is thus produced beneath the limbs. If the edge surfaces of the limbs have an adhesive coating, the panels not only adhere to the wall, but also to one another. The convection between the visible side and the gas-filled space in the direction perpendicular to the wall is thereby prevented or at least impeded so that a soundproofing and heat insulating effect can occur here.

FIG. 3 shows a wall cladding having panels that have a chamfered 9 edge surface 7. The chamfer can advantageously be on the installation of the panels since it compensates the production irregularities. A gas-filled space 8 beneath the limbs is also produced here by the arranging of the panels in rows.

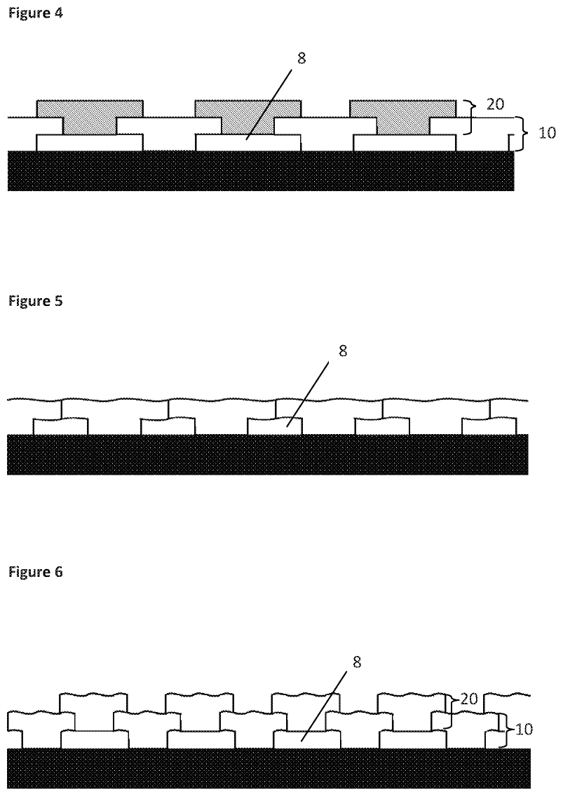

FIG. 4 shows a wall cladding that has two installation planes. The panels without hatching are located in the first installation plane 10. They each have a distance from one another that corresponds to the width of a web 2. The panels without hatching are located in the second installation plane 20. The panels of the second installation plane 20 are arranged horizontally offset from the panels of the first installation plane 10 so that the surface 4′ of the limbs 3 facing the installation side 6 lies completely on the surface of the limbs 3 facing the visible side 5 from the first installation plane 10. There is moreover also contact between the side surfaces of the webs 2 that belong to the panels of the second installation plane 20 and to the edge surfaces 7 of the limbs 3 that belong to the panels of the first installation plane 10. A sufficient surface for an adhesion between the panels of the first installation plane 10 and the panels of the second installation plane 20 is thus available.

FIG. 5 shows panels having a wave-like structure on the surface of the limbs 3 facing the visible side 5 and on the surface 4′ of the limbs 4 facing the installation side 6. The structure in this example is in the same direction with respect to the installation plane 6. If the surface describes a peak, the lower side 4′ also describes a peak. If the surface describes a valley, the lower side 4′ also describes a valley. A gas-filled hollow space beneath the limbs is also produced in this example by an arrangement of the panels in rows.

FIG. 6 shows that the panels from FIG. 5 can also be arranged in a first installation plane 10 and in a second installation plane 20 without gaps being produced in the boundary region between the first and second installation planes. The only gap is here again in the gas-filled hollow space 8.

FIG. 7 shows that the principle of the horizontally offset arrangement of panels can be continued as desired so that wall claddings having three or even more planes are produced. Yet a third installation plane 30 is namely added to the first installation plane 10 and to the second installation plane 20 in FIG. 7. Since the horizontal offset in the example is exactly half the total width of a panel, the projection of the panels in the third plane 30 again corresponds to the projection of the panels in the first plane 10. The panels in the first plane 10 are completely concealed for the observer on the visible side 5.

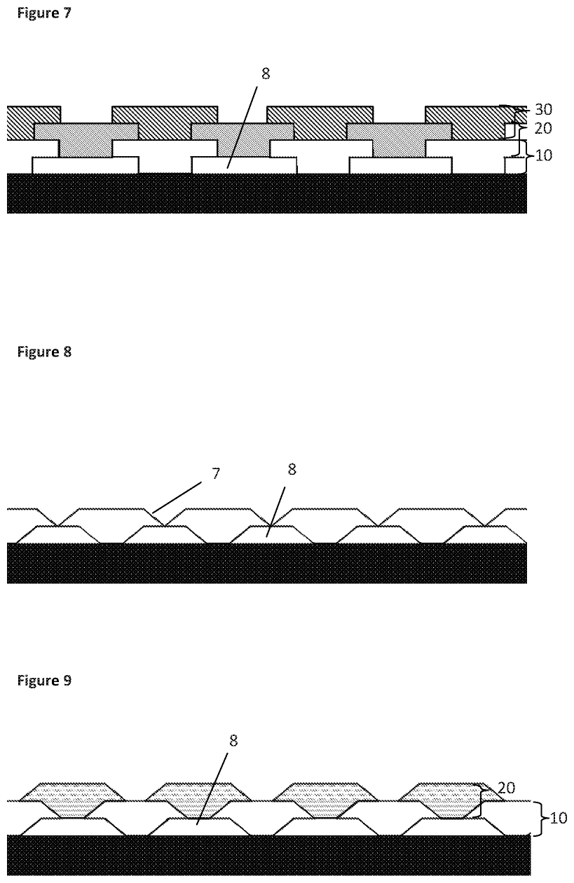

A further possible panel shape is shown in FIG. 8. The edge surfaces 7 of the limbs 3 are here not only chamfered, but are rather completely beveled. The cross-section of the web 2 has a trapezoidal shape

FIG. 9 shows how the panels of FIG. 8 can also be stacked to form a multilayer cladding. So that no further gaps arise between the installation planes 10 and 20, care must be taken that the side surface of the web has to be beveled in a complementary manner to the edge surface 7 of the oppositely disposed limb. The side surface of the web 2 and the oppositely disposed edge surface of the limb 3 together form an angle of 180°.

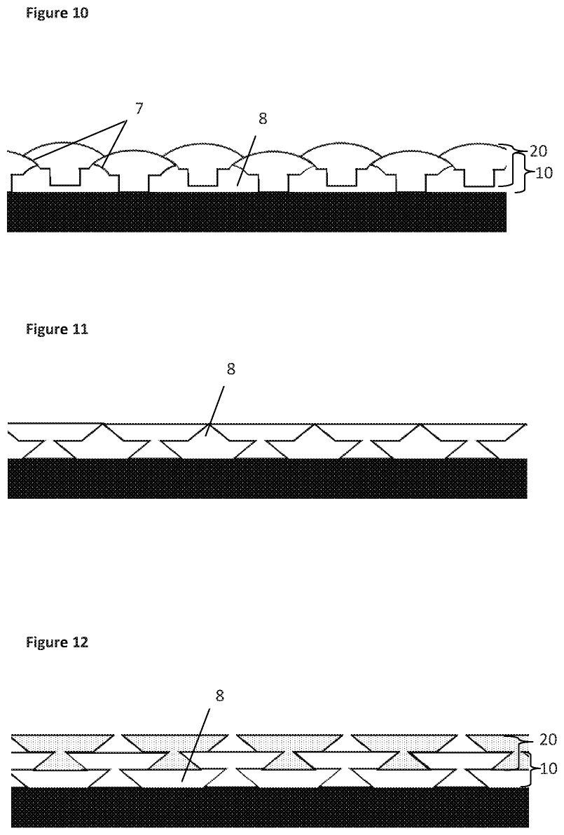

FIG. 10 shows a wall cladding composed of panels having curved edge surfaces. The curvature of the edge surface here corresponds exactly to the curvature of the limbs toward the visible side so that a gap-less stacking of the panels in two installation planes 10 and 20 is also possible here. The web 2 of the panels in the second installation plane 20 in this wall cladding projects very far into the gas-filled space 8.

FIGS. 11 and 12 show counter-pieces to the wall cladding of FIGS. 8 and 9. Whereas the web of the panels in FIGS. 8 and 9 is designed as obtuse angled and forms an acute angle with the plane of the wall, the web of the panels in FIGS. 11 and 12 is itself acute angled and accordingly includes an obtuse angle with the plane of the wall. Acute and obtuse angles in the limbs are also swapped over in comparison with the panels of FIGS. 8 and 9. However, as can be seen in FIG. 12, this different shape has no effect on the panels being able to be arranged in two installation planes 10 and 20 without further hollow spaces or gaps being produced beside the gas-filled space 8 between the wall and the panels of the first installation layer 10.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

1. A wall panel, ceiling panel, or floor panel comprising: a T-shaped profile, wherein the profile comprises a web at an installation side of the panel and two limbs at a visible side of the panel, wherein the web has a planar base surface and the base surface of the web and/or a surface of the limbs facing the installation side is coated regionally or all over with an adhesive.

2. The panel of claim 1, wherein the panel has a further adhesive coating at an edge surface of at least one limb.

3. The panel of claim 1, wherein the limbs are arranged axially symmetrically with respect to the web.

4. The panel of claim 1, wherein the limbs and the web are connected by shape matching and were produced from one piece.

5. The panel of claim 1, wherein the panel has a layer of a decor paper and/or of a veneering or a decor at the visible side.

6. The panel of claim 1, wherein the panel comprises a material selected from the group consisting of wood, wood materials, HDF, MDF, OSB, chipboard, plastic, PVC, cement fibers, plaster, metal, glass, ceramics, rock wool fiber materials, or any mixture thereof.

7. The panel of claim 1, wherein the adhesive is a pressure sensitive adhesive or a pressure sensitive adhesive on a polyacrylate or polyurethane base.

8. The panel of claim 1, wherein the adhesive coating is covered by a reversibly releasable release paper, or by a release paper comprising polyethylene or coated polyethylene.

9. The panel of claim 1, wherein the panel has a length of 100 to 2000 mm.

10. The panel of claim 1, wherein the edge surface of the limbs is coated with a protective lacquer, a UV hardening protective lacquer, and/or a protective lacquer selected from the group consisting of matte or gloss clear lacquer.

11. The panel of claim 1, wherein the edge surface of the limbs has a chamfer , a rounded portion, or a curvature at one side or at both sides, with the chamfer , the rounded portion, or the curvature coated with a UV hardening protective lacquer.

12. The panel of claim 1, wherein at least the surface of the limbs facing the visible side has an arching or a structure, wherein the structure comprises regular bulges and recesses.

13. The panel of claim 1, wherein the surface of the limbs facing the visible side and the surface of the limbs facing the installation side have a structure, wherein the structure of both surfaces is either in the same direction or in opposite directions with respect to the base surface of the web.

14. The panel of claim 1, wherein a right angle or a rounded transition is present between the surface of the limbs facing the installation side and the web.

15. A wall cladding, ceiling cladding, or floor cladding formed from a plurality of panels, each of the panels comprising: a T-shaped profile, wherein the profile comprises a web at an installation side of the panel and two limbs at a visible side of the panel, wherein the web has a planar base surface and the base surface of the web and/or a surface of the limbs facing the installation side is coated regionally or all over with an adhesive.

16. The wall cladding, ceiling cladding, or floor cladding of claim 15, wherein the panels are configured to be fastened to a wall, a ceiling, or a floor by an adhesive coating of the base surface of the web in a first installation plane.

17. The wall cladding, ceiling cladding, or floor cladding of claim 15, wherein the panels are arranged next to one another in rows in the first installation plane so that the edge surfaces of limbs of adjacent panels are adjacent to one another.

18. The wall cladding, ceiling cladding, or floor cladding of claim 15, wherein the panels in a second installation plane are fastened to the panels on the first installation plane by an adhesive coating on the surface of the limbs facing the installation side so that the panels of the first installation plane are at least partially concealed for an observer on the visible side by the panels of the second installation plane, with the edge surfaces of respective adjacent panels in the first installation plane being adjacent to a side surface of the web of a panel in the second installation plane.

19. The wall cladding, ceiling cladding, or floor cladding of claim 15, wherein the panels in a third installation plane are fastened to the panels of the second installation plane and/or to the panels of the first installation plane by an adhesive coating.

20. The wall cladding, ceiling cladding, or floor cladding of claim 15, wherein no further adhesive, no screws, nails, clamps, staples, or pins, and no further aids at all, are required for a permanent fastening of the panels.
